(19) United States
(12) Patent Application Publication
(10) Pub. No.: US 2009/0316807 A1
(43) Pub. Date: Dec. 24, 2009

(54) METHOD AND APPARATUS FOR ACHIEVING TRANSMIT DIVERSITY AND SPATIAL MULTIPLEXING USING ANTENNA SELECTION BASED ON FEEDBACK INFORMATION

(76) Inventors: Sang Gook Kim, San Diego, CA (US); Shu Wang, San Diego, CA (US); Young Cheul Yoon, San Diego, CA (US); Suk Woo Lee, San Diego, CA (US); Li-Hsiang Sun, San Diego, CA (US); Soon Yil Kwon, San Diego, CA (US); Ho Bin Kim, San Diego, CA (US)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/160,771

(22) PCT Filed: Jan. 15, 2007
(86) PCT No.: PCT/KR07/00237

§ 371 Date: Mar. 17, 2009

Related U.S. Application Data
(60) Provisional application No. 60/759,244, filed on Jan. 13, 2006.
(60) Provisional application No. 60/771,959, filed on Feb. 9, 2006.
(60) Provisional application No. 60/824,764, filed on Sep. 6, 2006.

(51) Int. Cl. H04L 27/00; H04K 1/10

(52) U.S. Cl. 375/260; 375/299

(57) ABSTRACT

A method of achieving transmit diversity in a wireless communication system is disclosed. The method comprises encoding and modulating data stream based on feedback information, demultiplexing symbols to at least one encoder block, encoding the demultiplexed symbols by the at least one encoder block, transforming the encoded symbols by at least one inverse fast Fourier transform (IFFT) block, and selecting antennas for transmitting the symbols based on the feedback information.

### TECHNICAL FIELD

The present invention relates to a method and apparatus for achieving transmit diversity and spatial multiplexing, and more particularly, to a method and apparatus for achieving transmit diversity and spatial multiplexing using antenna selection based on feedback information.

### BACKGROUND ART

Transmission and reception using multiple antennas is drawing more and more attention due to its potentially enormous capacity increase. Two modes of operation are assumed based on the availability of channel status information at the transmit side, namely, open-loop and closed-loop operations.

In the open-loop transmit diversity, channel status information is not assumed. Due to the lack of the channel status information, the open-loop transmit diversity often incurs performance loss. The open-loop transmit diversity is generally a simple operation. Alternatively, in the close-loop transmit diversity, a partial to full channel status information is assumed.

As discussed, the open-loop transmit diversity is a simple operation but performance loss occurs due to lack of channel status information. As for the closed-loop transmit diversity, better performance than open-loop can be attained, heavily depends on quality of channel status information (e.g., delay and error statistics of the feedback information).

### DISCLOSURE OF INVENTION

Accordingly, the present invention is directed to a method and apparatus for achieving transmit diversity and spatial multiplexing using antenna selection based on feedback information that substantially obviates one or more problems due to limitations and disadvantages of the related art.

An object of the present invention is to provide a method of achieving transmit diversity in a wireless communication system.

Another object of the present invention is to provide a method of allocating data symbols to specific antenna and frequency in a multi input, multi output (MIMO) system.

A further object of the present invention is to provide an apparatus for achieving transmit diversity in a wireless communication system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of achieving transmit diversity in a wireless communication system includes encoding and modulating data stream based on feedback information, demultiplexing symbols to at least one encoder block, encoding the demultiplexed symbols by the at least one encoder block, transforming the encoded symbols by at least one inverse fast Fourier transform (IFFT) block, and selecting antennas for transmitting the symbols based on the feedback information.

In another aspect of the present invention, a method of achieving transmit diversity in a wireless communication system includes demultiplexing data stream to at least one encoder block, performing channel coding and modulation to the demultiplexed data streams based on feedback information, encoding symbols by the at least one encoder block, transforming the encoded symbols by at least one inverse fast Fourier transform (IFFT) block, and selecting antennas for transmitting the symbols based on the feedback information.

In a further aspect of the present invention, a method of allocating data symbols to specific antenna and frequency in a multi input, multi output (MIMO) system includes encoding at least one data symbol by at least one encoder block, transforming the encoded symbols by at least one inverse fast Fourier transform (IFFT) block, assigning by at least one antenna selector at least one antenna for transmitting the encoded symbols based on feedback information, and assigning by the at least one antenna selector at least one carrier on which the data symbol is transmitted based on the feedback information.

Yet, in another aspect of the present invention, an apparatus for achieving transmit diversity in a wireless communication system includes a channel encoder and a modulator configured to encode and modulate, respectively, data stream based on feedback information, a demultiplexer configured to demultiplex symbols to at least one encoder block, an encoder configured to encode the demultiplexed symbols by the at least one encoder block, an inverse fast Fourier transform (IFFT) block configured to transform the encoded symbols, and an antenna selector configured to select antennas for transmitting the IFFT transformed symbols based on the feedback information

It is to be understood that both the foregoing general description and the following detailed description of the present invention are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is an exemplary diagram illustrating transmit diversity combined with antenna selection;

FIG. 2 is another exemplary diagram illustrating transmit diversity combined with antenna selection;

FIG. 3 is an exemplary diagram illustrating antenna selection and frequency allocation;

FIG. 4 is another exemplary diagram illustrating antenna selection and frequency allocation;

FIG. 5 is an exemplary diagram illustrating spatial multiplexing transmission with antenna selection;

FIG. 6 is another exemplary diagram illustrating spatial multiplexing transmission with antenna selection;

FIG. 7 is an exemplary diagram illustrating transmit diversity combined with antenna selection;

FIG. 8 is an exemplary diagram illustrating transmit diversity combined with antenna selection;

FIG. 9 is an exemplary diagram showing the operation for providing enhanced performance to users in the cell-edge region;

FIG. 10 is another exemplary diagram showing the operation for providing enhanced performance to users in the cell-edge region;

FIG. 11 is an exemplary diagram illustrating transmit diversity with soft handoff support utilizing new pilots to group of cells or sectors equipped with one transmit antenna;

FIG. 12 is another exemplary diagram illustrating transmit diversity with soft handoff transmission for MCW operation; and

FIG. 13 is an exemplary diagram of an apparatus for achieving transmit diversity and spatial multiplexing using antenna selection based on feedback information.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention can be applied to orthogonal frequency division multiplexing (OFDM) as well as multi-carrier code division multiple access (MC-CDMA) transmission architectures. The architectures to be discussed focuses on efficiently combining multi-carrier operations with multiple transmit antenna configurations. In detail, multi-carrier includes multiple bandwidths. For example, the bandwidth can be a multiple of 1.25 MHz, 5 MHz, or a sub-band of OFDM. Moreover, multi-carrier can exist in a distinct or overlapped fashion. In addition, multi-carrier can be defined by a single carrier as a subset.

Further, the architectures are designed to utilize the resources in time, frequency, and spatial domains efficiently in order to maximize the throughput and/or coverage. In addition, the architectures are designed to reduce complexity associated with generating feedback information from the receiving end and to support wide range of user mobility.

As discussed above, performance loss in terms of throughput can occur as a result of lack of channel status information and/or heavy dependence of the quality of channel status information. To address the performance loss problem, discussions of architectures related to joint transmit diversity based on encoding (e.g., space-time coding (STC)) and antenna selection based on channel status information will be made. Further, the discussions relate to architectures for joint spatial multiplexing based on encoding (e.g, non-orthogonal space-time coding) as well as antenna selection based on channel status information.

Antenna selection provides highest signal-to-interference-plus noise ratio (SINR) when the instantaneous channel status is available at the transmit side or channel varies slowly. Hence, the architectures to be discussed perform well in the case of low mobility like indoor application. However, the performance degradation manifest if the channel varies relatively faster than the time required to feedback the channel status to the transmitter.

In the discussions of various architectures to follow, there are several assumptions that can be made. For example, the architectures are designed for downlink high speed packet data (HSDPA) transmission and apply an orthogonal frequency division multiplexing (OFDM) scheme. Furthermore, the assumptions can include N number of 1.25 MHz bandwidths even though it can be applicable to arbitrary bandwidth of operation, and the adjacent bandwidths are not overlapped. Moreover, feedback in available which can be construed as a closed loop operation, and the feedback is per 1.25 MHz. Further, the assumptions can be made as to a number of transmit antennas (T) being greater than the output of the space-time code (STC) encoder. Lastly, as another assumption, the receiving end can be equipped with more than one antenna element so as to provide spatial multiplexing gain or additional diversity gain.

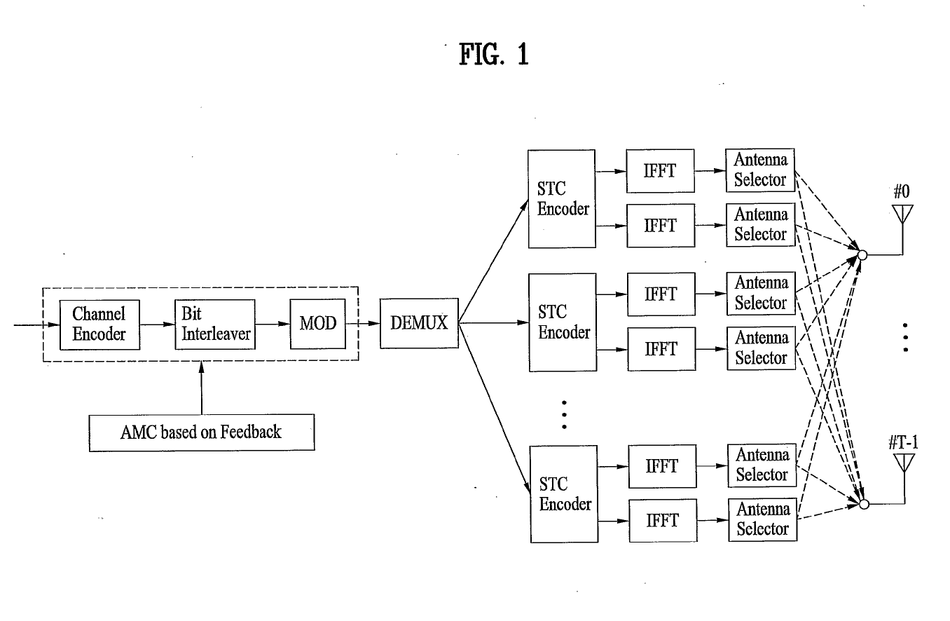

FIG. 1 is an exemplary diagram illustrating transmit diversity combined with antenna selection. Referring to FIG. 1, data stream is encoded based on feedback information provided from the receiving side. More specifically, based on the feedback information, the data is processed using an adaptive modulation and coding (AMC) scheme at the transmitting end. The data processed according to the AMC scheme is channel coded, interleaved, and then modulated into symbols (which can also be referred to as coded or modulated data stream).

The symbols are then demultiplexed to multiple STC encoder blocks. Here, demultiplexing is based on the code rate and modulation that the carrier can support. Each STC encoder block encodes the symbols and outputs to encoded symbols to inverse fast Fourier transform (IFFT) block(s). The IFFT block transforms the encoded symbols. The transformed symbols are then assigned to antennas selected by antenna selector(s) for transmission to the receiving end. The selection as to which antenna to be used for transmission can be based on the feedback information.

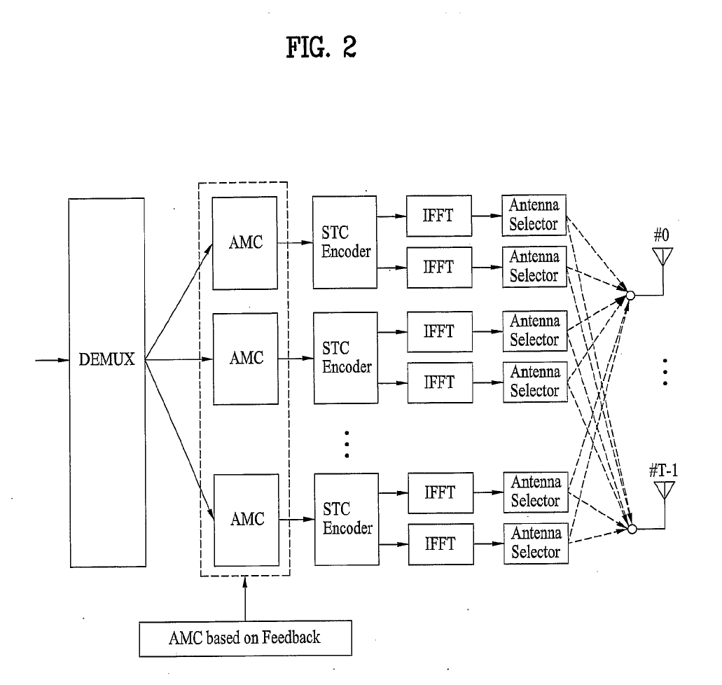

FIG. 2 is another exemplary diagram illustrating transmit diversity combined with antenna selection. Different from FIG. 1 which is designed for a single codeword (SWC) operation, in FIG. 2, adaptive modulation and coding is performed per carrier basis and is designed for a multiple codeword (MWC) operation.

According to FIGS. 1 and 2, the data is processed by the STC encoders before being processed by the IFFT block(s). However, it is possible for the data to be processed by the IFFT block before being processed by the STC encoder blocks. In short, the processing order between the STC encoders and the IFFT blocks can be switched.

In detail, the feedback information from the receiving end can be used in performing channel coding and modulation (or in executing the AMC scheme) to the data stream. This AMC scheme process is illustrated in a dotted box. The feedback information used in channel coding and modulation can be a data rate control (DRC) or a channel quality indicator (CQI), for example. Further, the feedback information can include various information such as sector identification, carrier/frequency index, antenna index, supportable CQI value, best antenna combination, selected antennas, and a supportable signal-to-interference noise ratio (SINR) for a given assigned multi-carriers.

The information related to selected antennas as well as its supportable SINR can be transmitted through a channel from the receiving end to the transmitting end (e.g., reverse link) or on a different channel. Such a channel can be a physical channel or a logical channel. Further, the information related to the selected antennas can be transmitted in a form of a bitmap. The position of each bitmap represents the antenna index.

The DRC or the CQI, for example, can be measured per transmit antenna. As an example of the CQI, a transmitting end can send signal (e.g., pilot) to a receiving end to determine the quality of the channel(s) through which the signal was sent. Each antenna transmits its own pilot for the receiving end to extract the channel information from the antenna element to the receiving end. The transmitting end can also be referred to as an access node, base station, network, or Node B. Moreover, the receiving end can also be referred to as an access terminal, mobile terminal, mobile station, or mobile terminal station. In response to the signal from the transmitting end, the receiving end can send to the transmitting end the CQI to provide the channel status or channel condition of the channel through which the signal was sent.

Furthermore, the feedback information (e.g., DRC or CQI) can be measured using a pre-detection scheme or a post-detection scheme. The pre-detection scheme includes inserting antenna-specific known pilot sequence before an orthogonal frequency division multiplexing (OFDM) block using a time division multiplexing (TDM). The post-detection scheme involves using antenna-specific known pilot pattern in OFDM transmission.

Further, the feedback information is based on each bandwidth or put differently, the feedback information includes the channel status information on each of N number of 1.25 MHz, 5 MHz, or a sub-band of OFDM bandwidth.

As discussed, the symbols processed using the AMC scheme are demultiplexed to multiple STC encoder blocks. The STC encoder blocks can implement various types of coding techniques. For example, the encoder block can be a STC encoder. Each STC encoder can have a basic unit of MHz. In fact, in FIG. 1, the STC encoder covers 1.25 MHz. Other types of coding techniques include space-time block code (STBC), non-orthogonal STBC (NO-STBC), space-time Trellis coding (STTC), space-frequency block code (SFBC), space-time frequency block code (STFBC), cyclic shift diversity, cyclic delay diversity (CDD), Alamouti, and precoding.

As discussed, the IFFT transformed symbols are assigned to specific antenna(s) by the antenna selectors based on the feedback information. That is, in FIG. 1, the antenna selector chooses the pair of antenna corresponding to two outputs from the STC encoder specified in the feedback information.

The antenna selectors select the antennas for transmitting specific symbols. At the same time, the antenna selector can choose the carrier (or frequency bandwidth) through which the symbols are transmitted. The antenna selection as well as frequency selection is based on the feedback information which is provided per each bandwidth of operation. Furthermore, the wireless system in which antenna and frequency allocation is made can be a multi input, multi output (MIMO) system.

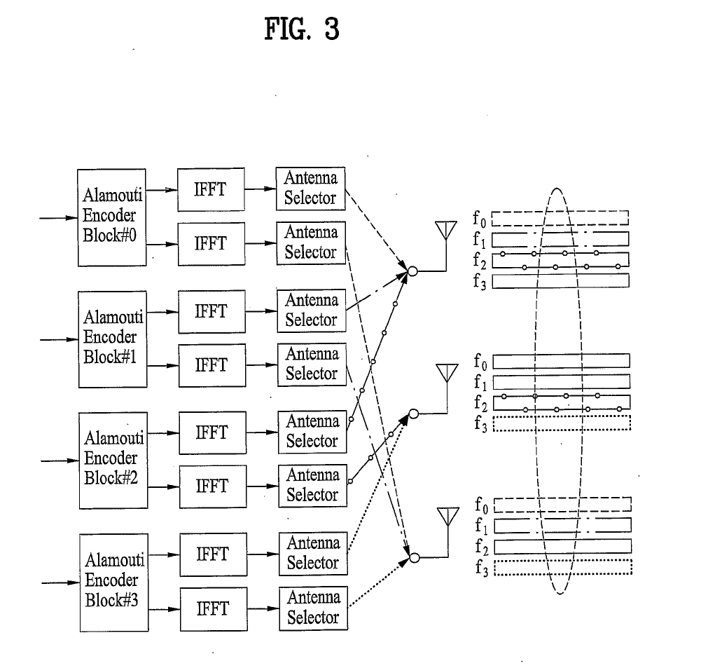

FIG. 3 is an exemplary diagram illustrating antenna selection and frequency allocation. Referring to FIG. 3, there are four (4) frequency bandwidths or carriers and three (3) antennas. Here, the symbols processed through Alamouti encoder Block #0 are assigned to antennas by the antenna selectors. The symbols from Block #0 are assigned to a first antenna on frequency 0 (f₀) from a first of two antenna selectors. At the same time, the other symbols of Block #0 are assigned to a third antenna on frequency on frequency 0 (f₀) from the other antenna selector. Moreover, the symbols from Block #3 are assigned to a second antenna on frequency 3 (f₃) from a first of two antenna selectors. At the same time, the other symbols of Block #3 are assigned to a third antenna on frequency on frequency 3 (f₃) from the other antenna selector. With respect to frequency allocation, frequency allocation is maintained for at least two consecutive OFDM symbol intervals.

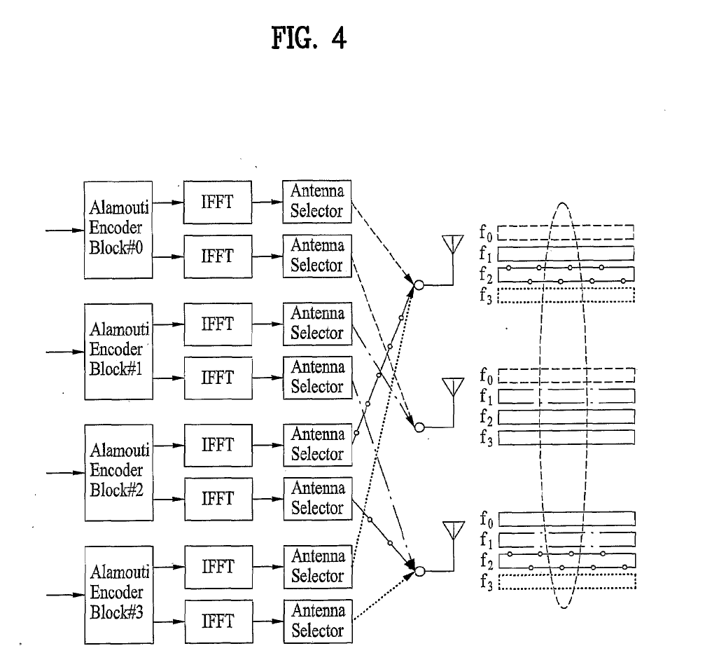

Similarly, FIG. 4 is another exemplary diagram illustrating antenna selection and frequency allocation. In FIGS. 3 and 4, the data symbols from each block are assigned to different antennas so as to achieve diversity gain.

As for execution by the antenna selectors or with respect to achieving selection diversity, a scheduler can be used. There are various types of schedulers available, among which is a proportional fair (PF) scheduler. The PF scheduler selects a user (or an access terminal) by comparing the ratio of their current transmission rates with their past-averaged throughputs and selecting the user with highest ratio. The PF scheduler can be considered as a good compromise between the throughput and user fairness.

The PF scheduler can be executed according to many possible scheduling algorithms. For example, the algorithms can be related to joint distribution of users to carries and antennas and to individual distribution of users to carriers and antennas.

As one of an example of a scheduling algorithm, users can be sorted based on PF values, and a user can be selected based on the user having the largest PF value. Further, the carrier (or frequency) and antenna combinations provided through the feedback information can be sorted based on the CQI value, for example. Thereafter, the carrier and antenna combination that provides the best CQI value can be assigned. The PF values of the users, including the selected user's PF value, can be recomputed.

Based on the re-computation, if the PF value of the selected user is still greater than the PF values of the rest of the users, then the carrier and antenna combination can be maintained and assigned. Otherwise, a user having the largest PF value can be selected and assigned. More specifically, the user can be selected and assigned to different carrier antenna combination that gives the next CQI value if the best CQI comes from the same carrier previously assigned. Alternatively, the user can be selected and assigned to the carrier and antenna combination that gives the best CQI value if the best CQI does not come from the same carrier previously assigned. The scheduling algorithm of this example can be repeatedly executed until all users are scanned and/or all possible carrier and antenna combinations are assigned.

According to another example regarding scheduling algorithms, the users can be sorted based on PF values, and a user can be selected based on the user having the largest PF value. Thereafter, carrier and antenna combination can be assigned to the selected user unless the CQI value is less than a pre-determined threshold value. For a specific carrier and antenna combination that has the CQI value less than the pre-determined threshold value, a user having the largest PF value among the rest of the users whose CQI is greater than or equal to the predetermined threshold value for that carrier can be selected. The scheduling algorithm of the second example can be repeatedly executed until all users are scanned and/or all possible carrier and antenna combinations are assigned.

According to yet another example regarding scheduling algorithms, the users can be distributed over carriers. More specifically, for j=0: N−1, in which N is the number of 1.25 MHz carriers as an example, and for i=0: T−1, in which T is the number of antenna elements, user index u(j, i) with the largest value of PF values at (j, i) for whom feedback indicates service at (j, i) can be assigned. Alternatively, for j=0: M−1, user and antenna pair (u(j), t) such that

$${max}_{i ∈ \{ 0 , … , T - 1 \}} \{ CQI ( j , i ) \}$$

can be determined. Here, the PF value for each carrier and each user is necessary.

For achieving transmit diversity gain, a number of transmit antennas (T) can be equal to a number of STC encoder output (M). In other words, M T. The feedback information from the receiving end can include sector identification, carrier index, and measured channel information (e.g., average SINR or instantaneous SINR). Using the feedback information, channel coding and modulation can be performed as well as antenna and frequency selection can be made. For example, if the feedback information is indicated as (‘2’, (0, 2), 5 dB), such an indication represents the feedback information on user 2 and carrier 0 and reception from the antennas indexed 0 and 2 gives the average SINR of 5 dB. Using the information, the downlink transmission can include information regarding medium access control (MAC) index for selected user, carrier index, and AMC index. For example, (‘2’, (0, 2), ‘5’) indicates AMC index of 5 and a code rate=½ and QPSK. The antennas indexed 0 and 2 are involved in this transmission.

As one of an example of a scheduling algorithm related to transmit diversity, users can be sorted based on PF values, and a user can be selected based on the user having the largest PF value. Further, the carrier (or frequency) provided through the feedback information can be sorted based on the average SNR value, for example. Thereafter, the carrier that provides the best SNR value can be assigned. The PF values of the users, including the selected user's PF value, can be recomputed.

Based on the re-computation, if the PF value of the selected user is still greater than the PF values of the rest of the users, then the carrier can be maintained and assigned. Otherwise, a user having the largest PF value can be selected and assigned. More specifically, the user can be selected and assigned to different carrier antenna combination that gives the next SNR value if the best average SNR comes from the same carrier previously assigned. Alternatively, the user can be selected and assigned to the carrier and antenna combination that gives the best average SNR value if the best average SNR does not come from the same carrier previously assigned. The scheduling algorithm of this example can be repeatedly executed until all users are scanned and/or all possible carrier and antenna combinations are assigned.

According to another example regarding scheduling algorithms related to transmit diversity, the users can be sorted based on PF values, and a user can be selected based on the user having the largest PF value. Thereafter, carrier and antenna combination can be assigned to the selected user unless the average SNR value is less than a pre-determined threshold value. For a specific carrier and antenna combination that has the average SNR value less than the pre-determined threshold value, a user having the largest PF value among the rest of the users whose average SNR is greater than or equal to the predetermined threshold value for that carrier can be selected. The scheduling algorithm of the second example can be repeatedly executed until all users are scanned and/or all possible carrier and antenna combinations are assigned.

According to yet another example regarding scheduling algorithms related to transmit diversity, the users can be distributed over carriers. More specifically, for j=0: N−1, in which N is the number of 1.25 MHz carriers, user index u(j) with the largest value of PF values at jth carrier for whom feedback indicates service at carrier j can be assigned. Here, the PF value for each carrier and each user is necessary.

Alternatively, the number of transmit antennas (T) can be greater than the number of STC encoder outputs (M) (e.g., M<T). This can be considered as antenna selection plus transmit diversity. In implementing this, the feedback information can include sector identification (can be substituted by pilot pattern), carrier index, antenna indices, and achievable average SNR. Here, user identification can be considered implicit. For example, (‘2’, 0, (0,2), 5 dB) indicates a user in Sector 2 and carrier 0, and the reception from transmit antennas 0 and 2 is optimized with the average SNR of 5 dB.

The selected antennas and corresponding channel quality information (CQI) or data rate control (DRC) information can be delivered using the same of different channels. One channel can deliver the information on the selected antennas, for example, using a bitmap, and the other channel can deliver the corresponding CQI or DRC information. In addition, as discussed above, the information regarding the selected antennas can be transmitted in bitmap form, and the position of each bitmap can represent antenna index. The positions in bitmap represent the corresponding physical and effective antennas. For example, a 4-bit bitmap can represent four (4) physical or effective antennas and (0 1 0 1) denotes the second and fourth physical or effective antennas selected. A field in uplink (reverse) control information for the access network can be placed and used to interpret the field as for STC plus antenna selection selected by the access terminal.

First, the average SNR or instantaneous SNR per transmit antenna combination needs to be measured. This measurement can be based on a forward common pilot channel (F-CPICH) or a dedicated pilot channel (F-DPICH). The measured SNR can be measured by using a pre-detection method and/or a post-detection method. The pre-detection method includes inserting antenna-specific known pilot sequence before the OFDM block (TDM), and the post-detection method includes using antenna specific pilot pattern(s) in OFDM block.

In the downlink transmission, information regarding MAC index for the selected user, carrier index, antenna indices, and the AMC index can be included. For example, if the information is indicated by (‘2’, 0, (0,2), ‘5’), then such an indication represents AMC index of 5 with a code rate of ½ and QPSK. A field in downlink (forward) control information for the access terminal can be placed and used to interpret the field as for STC plus antenna selection. Moreover, this field can be used for operation(s) based on common pilot channel and/or dedicated pilot channel.

With respect to downlink transmission, control signaling can be used to provide the receiving end that the current transmission includes information regarding the transmission schemed used as well as antenna selection. For example, the information includes that spatial time transmit diversity (STTD) and antenna selection is being used. Further, the information can contain modulation and coding related information as well.

As one of an example of a scheduling algorithm related to transmit diversity, users can be sorted based on PF values, and a user can be selected based on the user having the largest PF value. Further, the carrier (or frequency) and antenna indices combinations provided through the feedback information can be sorted based on the average SNR value, for example. Thereafter, the carrier and antenna combination that provides the best average SNR value can be assigned. The PF values of the users, including the selected user's PF value, can be recomputed.

Based on the re-computation, if the PF value of the selected user is still less than the PF values of the rest of the users, then the carrier and antenna combination giving the next average SNR value can be assigned. Otherwise, a user having the largest PF value can be selected and assigned. More specifically, the user can be selected and assigned to different carrier antenna combination that gives the next average SNR value if the best average SNR comes from the same carrier previously assigned. Alternatively, the user can be selected and assigned to the carrier and antenna combination that gives the best average SNR value if the best average SNR does not come from the same carrier previously assigned. The scheduling algorithm of this example can be repeatedly executed until all users are scanned and/or all possible carrier and antenna combinations are assigned.

According to another example regarding scheduling algorithms related to transmit diversity, the users can be sorted based on PF values, and a user can be selected based on the user having the largest PF value. Thereafter, carrier and antenna combination can be assigned to the selected user unless the measured SNR value is less than a pre-determined threshold value. For a specific carrier and antenna combination that has the measured SNR value less than the pre-determined threshold value, a user having the largest PF value among the rest of the users whose SNR is greater than or equal to the predetermined threshold value for that carrier can be selected. The scheduling algorithm of the second example can be repeatedly executed until all users are scanned and/or all possible carrier and antenna combinations are assigned.

According to yet another example regarding scheduling algorithms related to transmit diversity, the users can be distributed over carriers. More specifically, for j=0: M−1, in which M is the number of 1.25 MHz carriers, and for i=0: T−1, in which T is the number of antenna elements, user index u(j, i) with the largest value of PF values at (j, i) for whom feedback indicates service at (j, i) can be assigned. Alternatively, for j=0: M−1, user and antenna pair (u(j), t) such that

$${max}_{i ∈ \{ 0 , … , T - 1 \}} \{ S N R ( j , i ) \}$$

can be determined. Here, the PF value for each carrier and each user is necessary.

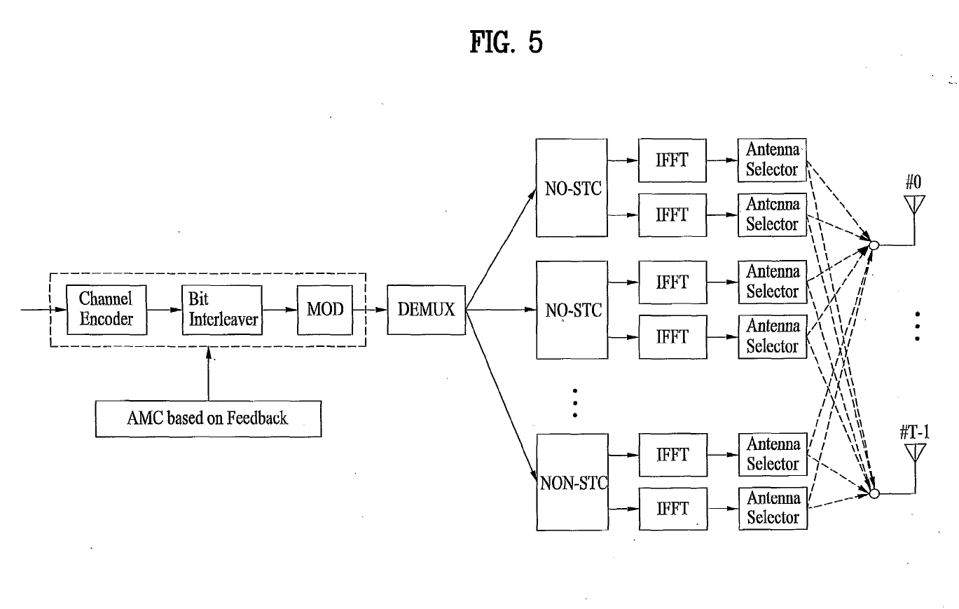

FIG. 5 is an exemplary diagram illustrating spatial multiplexing transmission with antenna selection. Instead of using space-time encoder, as illustrated in FIGS. 1 and 2, in FIG. 5, non-orthogonal space-time code (NO-STC) encoder is used to give more than rate 1 transmission rate. Aside from using the NO-STC encoder, the other processes are the same to those of FIG. 1. That is, the data stream is channel coded and modulated based on the feedback information (e.g., DRC or CQI), and the antenna selection/frequency selection is made based on the feedback information. Furthermore, the receiving side can be equipped with more than one antenna element so as to properly extract or separate the multiplexed streams.

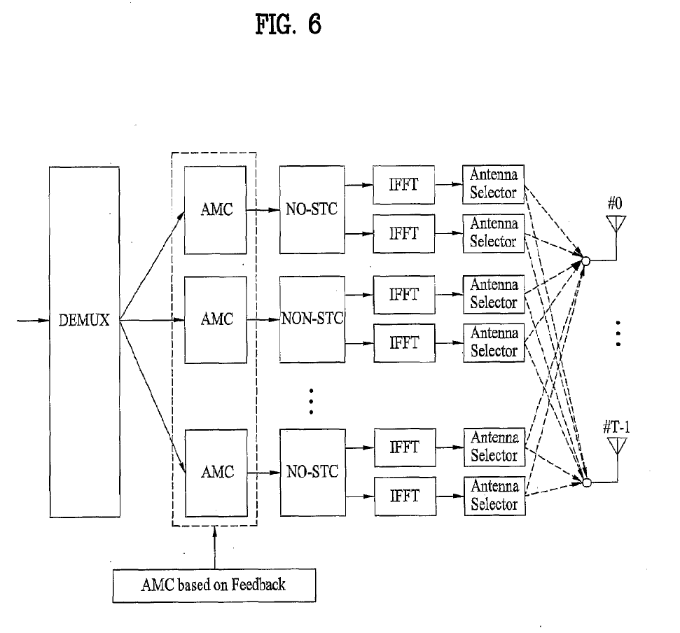

FIG. 6 is another exemplary diagram illustrating spatial multiplexing transmission with antenna selection. The architecture of FIG. 6 is similar to the architecture of FIG. 2 in that the AMC is performed per carrier basis. In short, FIG. 6 relates to MCW.

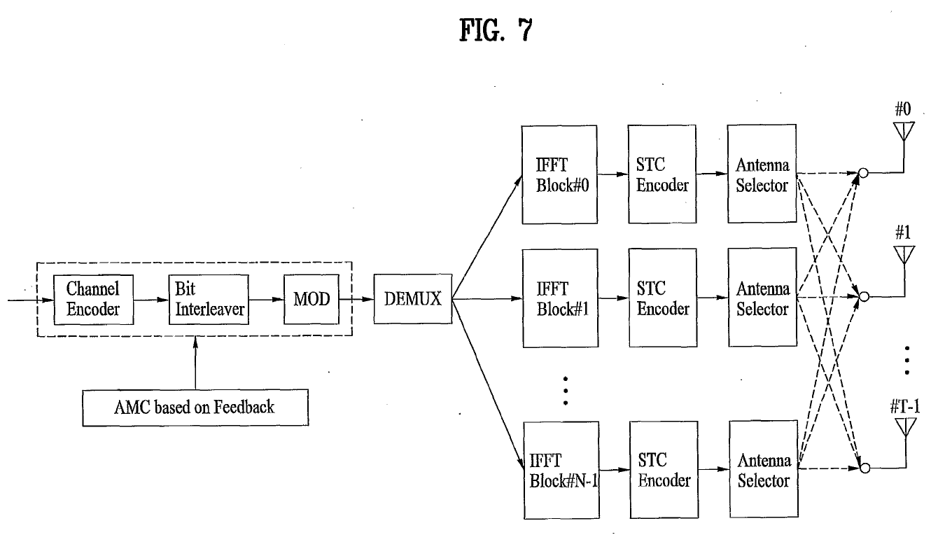

FIG. 7 is an exemplary diagram illustrating transmit diversity combined with antenna selection. The architecture of FIG. 7 is similar to that of FIG. 1 in that it is designed for a single codeword (SCW) operation except that the positions of the encoder blocks and the IFFT blocks are switched. In FIG. 7, IFFT transforming takes place before encoding by the encoder blocks.

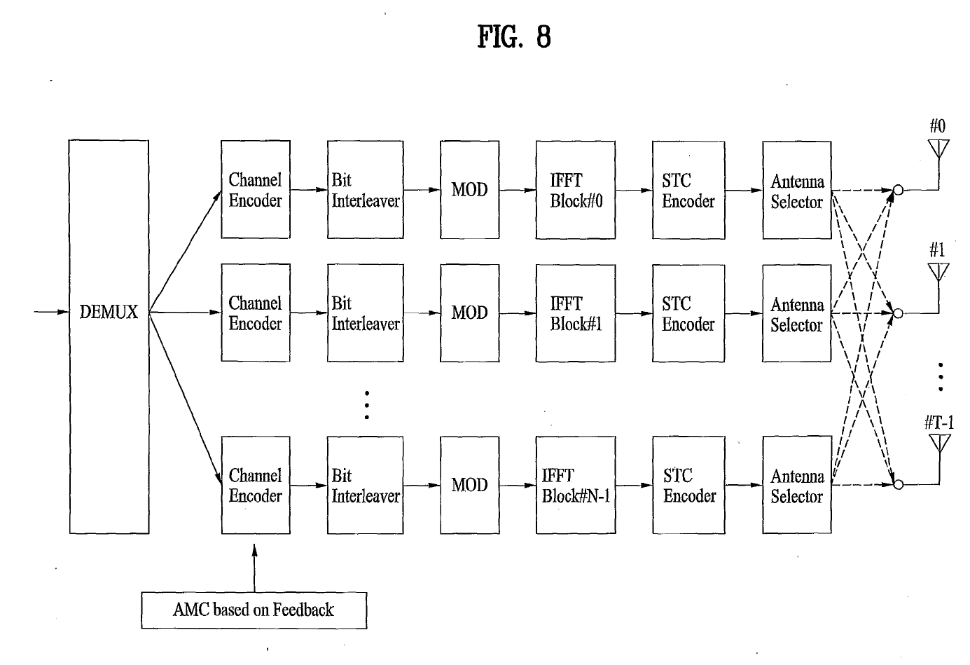

FIG. 8 is an exemplary diagram illustrating transmit diversity combined with antenna selection. The architecture of FIG. 8 is similar to that of FIG. 2 in that it is designed for a multiple codeword (MCW) operation except that the position of the encoder blocks and the IFFT blocks are switched. In FIG. 8, IFFT transforming takes place before encoding by the encoder blocks.

It is possible for the architectures illustrated in FIGS. 7 and 8 to be used to support spatial multiplexing. More specifically, the STC block can be replaced or substituted with non-orthogonal STC blocks (e.g., NO-STBC), for example.

By combining transmit diversity and spatial multiplexing with antenna selection in a unified manner, architectures that provide antenna selection gain to stationary to low-speed users and diversity gain to medium- to high-speed user.

With respect to transmit diversity with joint antenna selection, the antenna selection can be based on the feedback information and transmit diversity applied over subset of selected antenna elements. Further, the antenna selection is dominant source of gain for low mobility and transmit diversity provides gain even for relatively high mobility in terms of received SINR.

With respect to spatial multiplexing with joint antenna selection, the antenna selection can be base on the feedback information and spatial multiplexing can be applied over subset of selected antenna elements to increase transmit data rate. Further, non-orthogonal space time block code (NO-STBC) is a possible choice, for example, due to its simple implementation. The receiving end can be required to be equipped with more than one antenna element.

The embodiments of the present invention can be applied in multiple cell (or sectors) environment. In other words, the present invention can be applied to soft handoff/handover situation. With respect to soft handover/handoff, in order to provide enhanced performance to users in edges or boundaries of cell(s)/sector(s), the cells (or sectors) can be grouped. That is, the cells (or sectors) in the group can transmit the same signal (or waveform) to provide over-the-air (OTA) soft combining gain. Such an operation can be supported by having multiple antennas. More specifically, cyclic shift diversity or cyclic delay diversity transmission can be used to provide the OTA combining gain without notice from the receiving end.

As an example of cyclic shift or delay diversity, the feedback information can contain the best or optimum delay value in addition to antenna combination and supportable SINR which is used for AMC purpose. Here, the periodicity of optimum delay value feedback may be set per access terminal (AT) basis. The optimum delay value can be applied to the second antenna selected. The second antenna can be the antenna element with larger antenna index. Further, if preceding is assumed, antenna selector can act as a beamformer plus antenna selector.

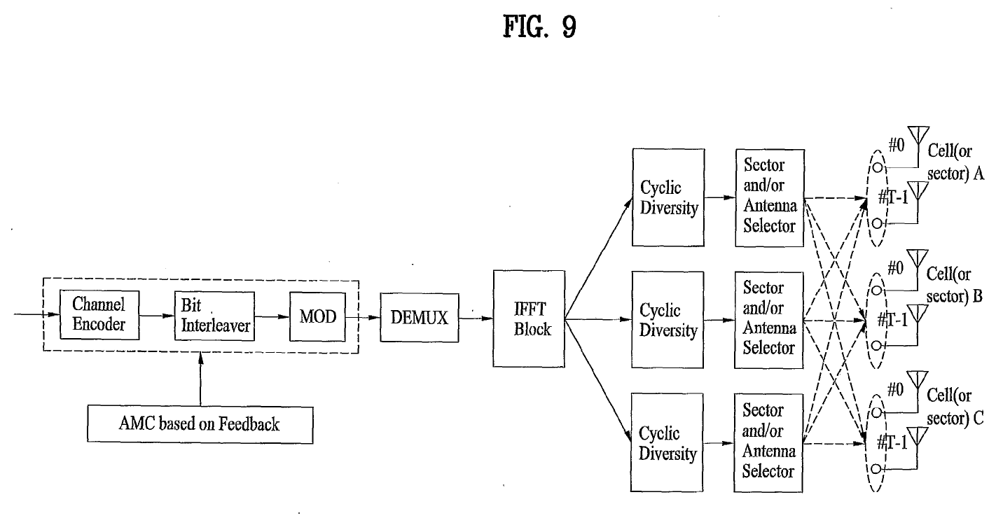

FIG. 9 is an exemplary diagram showing the operation for providing enhanced performance to users in the cell-edge region. Here, each cell or sector comprises multiple antennas, cyclic diversity (shift or delay), and SCW. As illustrated, the antennas in each cell or sector are grouped. In FIG. 9, the existing pilot can be used in the selection of cells (or sectors) involved to transmit the same signal. In the figure, the IFFT block can include more than one IFFT block so as to correspond with the encoders.

The IFFT block can be further described by serial-to-parallel conversion, IFFT, parallel-to-serial conversion, cyclic prefix insertion, digital/analog and low pass filter, and gain (or up conversion). Here, gain depends on the number of antenna element, available power, and feedback mechanism.

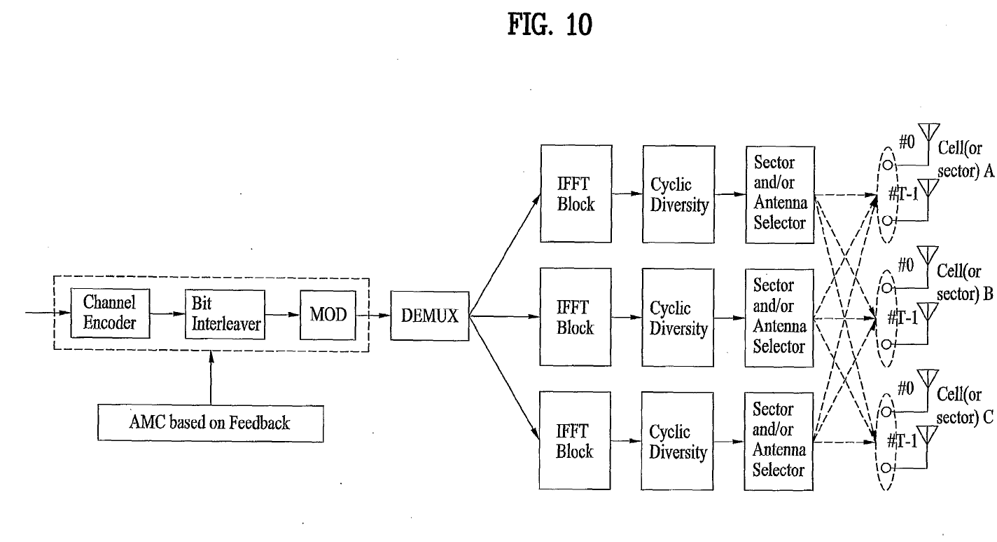

FIG. 10 is another exemplary diagram showing the operation for providing enhanced performance to users in the cell-edge region. In FIG. 10, new pilots are used in the selection of cells (or sectors) involved to transmit the same signal. In FIGS. 9 and 10, the cells or sectors involved in soft handoff transmission can be determined by either the access terminal or an access network.

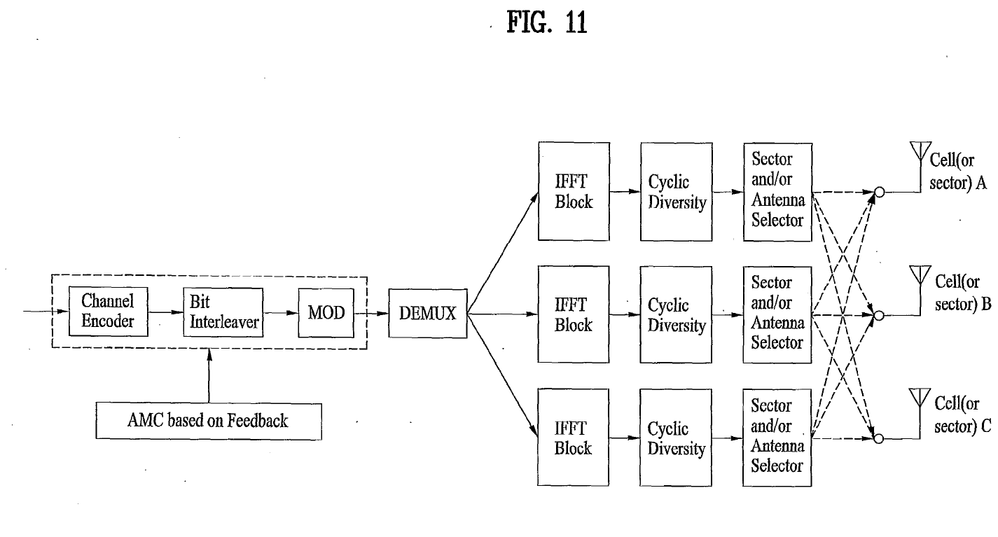

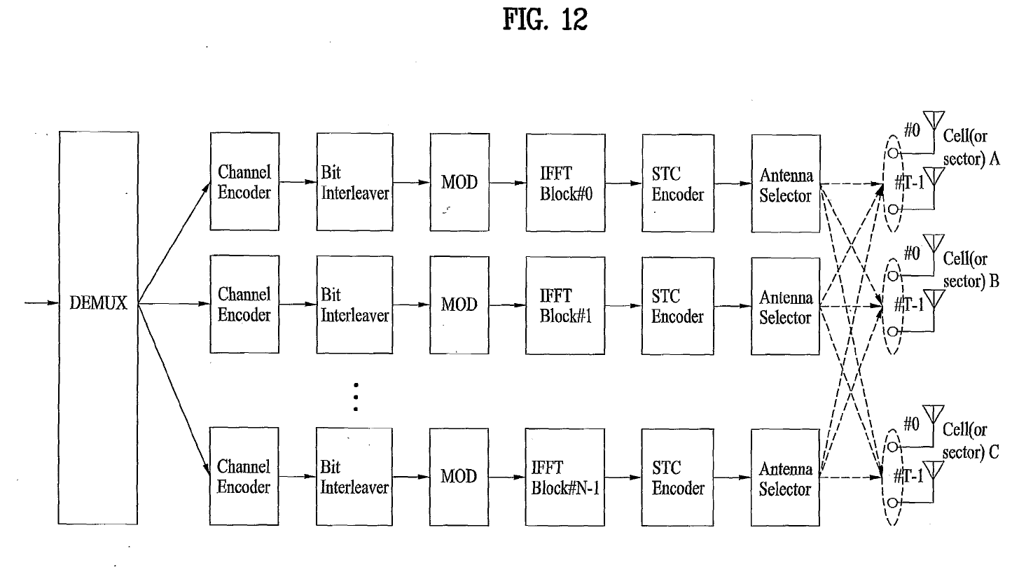

FIG. 11 is an exemplary diagram illustrating transmit diversity with soft handoff support utilizing new pilots to group of cells or sectors equipped with one transmit antenna. Same approach, as described in FIG. 10, can be used to support MCW with soft handoff transmission as shown in FIG. 12.

FIG. 12 is another exemplary diagram illustrating transmit diversity with soft handoff transmission for MCW operation. More specifically, FIG. 12 illustrates the architecture for MCW transmission with soft handoff transmission support. Here, the cells or sectors are equipped with multiple transmit antennas, and there are N number of layers (or carriers). Further, it is possible for each cell or sector to support a single antenna transmission for soft handoff transmission.

In FIGS. 9-12, the encoder block is indicated as using cyclic diversity (shift or delay) scheme. However, as discussed above, the encoder block can use other schemes such as space-time block code (STBC), non-orthogonal STBC (NO-STBC), space-time Trellis coding (STTC), space-frequency block code (SFBC), space-time frequency block code (STFBC), Alamouti, and precoding.

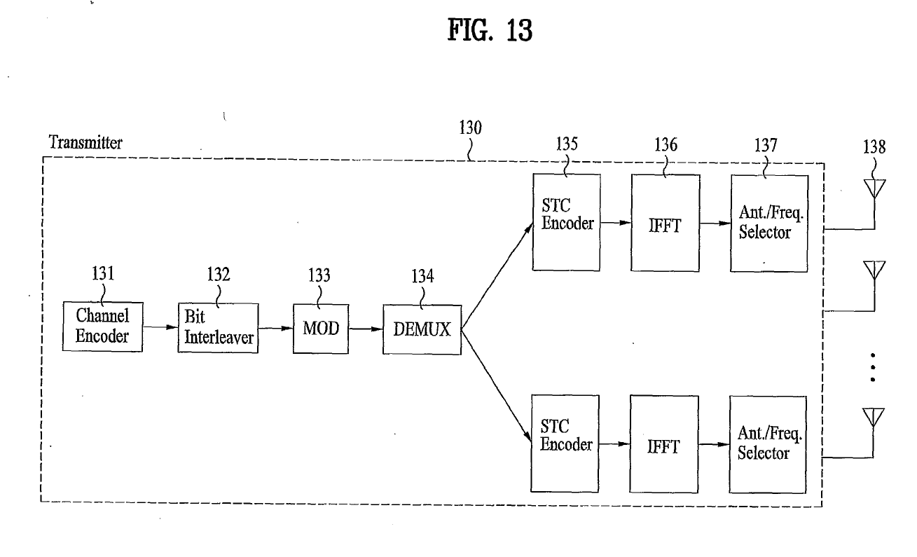

FIG. 13 is an exemplary diagram of an apparatus for achieving transmit diversity and spatial multiplexing using antenna selection based on feedback information. Referring to FIG. 13, the data stream is encoded based on feedback information provided from the receiving side at the transmitter 130. More specifically, based on the feedback information, the data is processed using an adaptive modulation and coding (AMC) scheme. The data processed according to the AMC scheme is channel coded by a channel encoder 131, interleaved by a bit interleaver 132, and then modulated into symbols by a modulator 133.

The symbols are then demultiplexed to multiple encoder blocks by a demultiplexer 134. Here, demultiplexing is based on the code rate and modulation that the carrier can support. Each encoder block 135 encodes the symbols and outputs to encoded symbols to inverse fast Fourier transform (IFFT) blocks 136. The IFFT block 136 transforms the STC encoded symbols. The transformed symbols are then assigned to antennas 138 selected by antenna selectors 137 for transmission to the receiving end. The selection as to which antenna to be used for transmission can be based on the feedback information.

As discussed, the location of the encoder 135 and the IFFT 136 can be switched. Furthermore, the encoder block 135 can use coding schemes such as STBC, NO-STBC, STTC, SFBC, STFBC, cyclic shift/delay diversity, Alamouti, and precoding.

### INDUSTRIAL APPLICABILITY

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of achieving transmit diversity in a wireless communication system, the method comprising:
encoding and modulating data stream based on feedback information;
demultiplexing symbols to at least one encoder block;
encoding the demultiplexed symbols by the at least one encoder block;
transforming the encoded symbols by at least one inverse fast Fourier transform (IFFT) block; and
selecting antennas for transmitting the symbols based on the feedback information.

2. The method of claim 1, wherein the encoding and modulating the data stream is based on an adaptive modulation and coding.

3. The method of claim 1, wherein the feedback information is a data rate control (DRC) or a channel quality indicator (CQI).

4. The method of claim 3, wherein the DRC or the CQI is measured per transmit antenna.

5. The method of claim 3, wherein the DRC or the CQI is measured using a pre-detection scheme which inserts antenna-specific known pilot sequence before an orthogonal frequency division multiplexing (OFDM) block using a time division multiplexing.

6. The method of claim 3, wherein the DRC or the CQI is measured using a post-detection scheme which uses antenna-specific known pilot pattern in an orthogonal frequency division multiplexing (OFDM) transmission.

7. The method of claim 1, wherein the feedback information includes the channel status information on each of N number of 1.25 MHz, 5 MHz, or a sub-band of orthogonal frequency division multiplexing (OFDM) bandwidth and wherein N is a positive integer.

8. The method of claim 1, wherein the feedback information includes sector identification, carrier/frequency index, antenna index, supportable channel quality indicator (CQI) value, best antenna combination, a supportable signal-to-interference noise ratio (SINR), and an average signal-to-noise ratio (SNR).

9. The method of claim 1, wherein the at least one encoder block uses any one of a space-time code (STC), non-orthogonal STBC (NO-STBC), space-time Trellis coding (STTC), space-frequency block code (SFBC), space-time frequency block code (STFBC), cyclic shift diversity, cyclic delay diversity, Alamouti, and precoding coding schemes.

10. The method of claim 1, wherein the antennas are selected using a proportional fair (PF) scheduler.

11. The method of claim 10, wherein the PF scheduler selects a user from multiple users by comparing their current transmission rates with their past-averaged throughputs and selecting the user having highest throughput.

12. The method of claim 1, wherein the symbols processed by each encoder are assigned to different antennas.

13. The method of claim 12, wherein the data streams are allocated to same carrier on different antennas.

14. The method of claim 13, wherein the symbols selected for transmission maintain at least two consecutive orthogonal frequency division multiplexing (OFDM) symbol intervals.

15. The method of claim 1, wherein processes carried out by the at least one encoder and the at least one IFFT block is executed in any order.

16. The method of claim 1, wherein a number of antenna selector corresponds to a number of the at least one IFFT blocks.

17. The method of claim 1, wherein the wireless communication system is a multi input, multi output (MIMO) system.

18. The method of claim 1, wherein the antennas are grouped per cell or sector.

19. The method of claim 18, wherein the selected antennas are designed to transmit to respective grouped antennas.

20. The method of claim 1, wherein each selected antenna represents a cell or a sector.

21. The method of claim 1, wherein the feedback information is transmitted via physical channel or a logical channel.

22. The method of claim 1, wherein the feedback information related to selected antennas is transmitted in bitmap, and positions of each bitmap represents an antenna index.

23. A method of achieving transmit diversity in a wireless communication system, the method comprising:
demultiplexing data stream to at least one encoder block;
performing channel coding and modulation to the demultiplexed data streams based on feedback information;
encoding symbols by the at least one encoder block;
transforming the encoded symbols by at least one inverse fast Fourier transform (IFFT) block; and
selecting antennas for transmitting the symbols based on the feedback information.

24. The method of claim 23, wherein the feedback information is a data rate control (DRC) or a channel quality indicator (CQI).

25. The method of claim 24, wherein the DRC or the CQI is measured per transmit antenna.

26. The method of claim 23, wherein the feedback information includes the channel status information on each of N number of 1.25 MHz, 5 MHz, or a sub-band of orthogonal frequency division multiplexing (OFDM) bandwidth and wherein N is a positive integer.

27. The method of claim 23, wherein the at least one encoder block uses any one of a space-time code (STC), non-orthogonal STBC (NO-STBC), space-time Trellis coding (STTC), space-frequency block code (SFBC), space-time frequency block code (STFBC), cyclic shift diversity, cyclic delay diversity, Alamouti, and preceding coding schemes.

28. The method of claim 27, wherein the symbols selected for transmission maintain at least two consecutive orthogonal frequency division multiplexing (OFDM) symbol intervals.

29. The method of claim 23, wherein processes carried out by the at least one encoder and the at least one IFFT block is executed in any order.

30. The method of claim 23, wherein a number of antenna selector corresponds to a number of the at least one IFFT blocks.

31. The method of claim 23, wherein the wireless communication system is a multi input, multi output (MIMO) system.

32. The method of claim 23, wherein the antennas are grouped per cell or sector.

33. The method of claim 32, wherein the selected antennas are designed to transmit to respective grouped antennas.

34. The method of claim 23, wherein each selected antenna represents a cell or a sector.

35. A method of allocating data symbols to specific antenna and frequency in a multi input, multi output (MIMO) system, the method comprising:
encoding at least one data symbol by at least one encoder block;
transforming the encoded symbols by at least one inverse fast Fourier transform (IFFT) block;
assigning by at least one antenna selector at least one antenna for transmitting the encoded symbols based on feedback information; and
assigning by the at least one antenna selector at least one carrier on which the data symbol is transmitted based on the feedback information.

36. The method of claim 35, wherein a number of antenna selector corresponds to a number of the at least one IFFT blocks.

37. The method of claim 35, further comprising:
encoding and modulating data stream based on feedback information; and
demultiplexing symbols to the at least one encoder block.

38. The method of claim 35, further comprising:
demultiplexing the symbols to the at least one encoder block; and
performing modulation and channel coding to the demultiplexed symbols based on feedback information.

39. The method of claim 35, wherein the feedback information is a data rate control (DRC) or a channel quality indicator (CQI).

40. The method of claim 39, wherein the DRC or the CQI is measured per transmit antenna.

41. The method of claim 35, wherein the feedback information includes the channel status information on each of N number of 1.25 MHz, 5 MHz, or a sub-band of orthogonal frequency division multiplexing (OFDM) bandwidth and wherein N is a positive integer.

42. The method of claim 35, wherein the at least one encoder block uses any one of a space-time code (STC), non-orthogonal STBC (NO-STBC), space-time Trellis coding (STTC), space-frequency block code (SFBC), space-time frequency block code (STFBC), cyclic shift diversity, cyclic delay diversity, Alamouti, and precoding coding schemes.

43. An apparatus for achieving transmit diversity in a wireless communication system, the apparatus comprising:
a channel encoder and a modulator configured to encode and modulate, respectively, data stream based on feedback information;
a demultiplexer configured to demultiplex symbols to at least one encoder block;
an encoder configured to encode the demultiplexed symbols by the at least one encoder block;
an inverse fast Fourier transform (IFFT) block configured to transform the encoded symbols; and
an antenna selector configured to select antennas for transmitting the IFFT transformed symbols based on the feedback information.

44. The apparatus of claim 43, wherein positions of the encoder and the IFFT block in the apparatus is interchangeable.

45. The apparatus of claim 43, wherein the apparatus is a transmitter.
